(19) United States
(12) Patent Application Publication
(10) Pub. No.: US 2009/0237252 A1
(43) Pub. Date: Sep. 24, 2009

(54) Radio communication system and radio communication apparatus

(75) Inventors: Satoshi Inano, Kawasaki (JP); Isamu Yamada, Kawasaki (JP); Shinichi Shiotsu, Kawasaki (JP); Akira Itasaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/379,542

(22) Filed: Feb. 24, 2009

(30) Foreign Application Priority Data
Mar. 24, 2008 (JP) 2008-076435

(51) Int. Cl. G08B 13/14

(52) U.S. Cl. 340/572.1

(57) ABSTRACT

The radio communication system includes a radio communication apparatus having: a communication part which transmits a request signal requesting a response to a radio tag; and a radio tag which transmits a response signal in response to a reception of the request signal from the radio communication apparatus. The radio communication apparatus has an intermittent control part which makes the communication part transmit the request signal at an interval of a given stop time during a given operation time.

### CROSS-REFERENCE TO RELATED APPLICATION(S)

This application is based upon and claims the benefit of priority of the prior Japanese Patent Application No. 2008-76435, filed on Mar. 24, 2008, the entire contents of which are incorporated herein by reference.

### BACKGROUND

1. Field

The embodiments discussed herein are directed to a radio communication system including a radio communication apparatus such as a reader-writer requesting a response to a radio tag and a radio tag responding to the request from the radio communication apparatus.

2. Description of the Related Art

Recently, a radio communication system which carries out management such as physical distribution management and information gathering with the use of an RFID (Radio Frequency Identification) tag has attracted attention. In the radio communication system using the RFID tag, a reader-writer performing radio communication with the RFID tag transmits a request signal requesting a response to the RFID tag, and the RFID tag which has detected the request signal transmits a response signal, including identification information for identifying itself, to the reader-writer. The reader-writer receives the identification information, and the received identification information is used for various managements.

FIG. 1 is a time chart illustrating a communication processing in the radio communication system. In the time chart of FIG. 1, transmission of the request signal and reception of the response signal in the reader-writer, and reception of the request signal and transmission of the response signal in the RFID tag are illustrated in sequence from the top. Time is illustrated in the horizontal direction, and the communication processing is illustrated in time series.

As illustrated in FIG. 1, the reader-writer continuously transmits the request signal and always stands by for receiving the response signal; therefore, the reader-writer can always receive the response signal. The RFID tag intermittently detects the presence of the request signal at a timing of CS (Career sense) in FIG. 1. When the RFID tag has detected the request signal, it receives the request signal as illustrated as RV (Receive) in FIG. 1 to transmit the response signal to the received request signal.

### SUMMARY

It is an aspect of embodiments discussed herein are directed to a radio communication system. The aspects can be provided by the system having a communication part, which transmits a request signal requesting a response to-a radio tag, and a radio tag which transmits a response signal in response to a reception of the request signal from the radio communication apparatus. The radio communication apparatus has an intermittent control part which makes the communication part transmit the request signal at an interval of a set stop time during a set operation time.

### BRIEF DESCRIPTION OF THE DRAWINGS

FIG. 1 illustrates a communication processing in a radio communication system.

FIG. 2 illustrates a radio communication system according to a first embodiment;

FIG. 3 illustrates an exemplary communication processing in a radio tag used in the radio communication system according to a first embodiment;

FIG. 4 illustrates exemplary intermittent processing in a radio communication apparatus used in the radio communication system according to a first embodiment;

FIG. 5 illustrates an exemplary transmission processing in the radio communication apparatus used in the radio communication system according to a first embodiment;

FIG. 6 illustrates an exemplary reception processing in the radio communication apparatus used in the radio communication system according to a first embodiment;

FIG. 7 illustrates exemplary communication processing in the radio communication system according to a first embodiment;

FIG. 8 illustrates a radio communication system according to a second embodiment;

FIG. 9 illustrates exemplary operation mode determination processing in a radio tag used in the radio communication system according to a second embodiment;

FIG. 10 illustrates exemplary operation control processing in the radio tag used in the radio communication system according to a second embodiment;

FIG. 11 illustrates an exemplary communication processing in the radio tag used in the radio communication system according to a second embodiment;

FIG. 12 illustrates exemplary operation mode determination processing in the radio communication apparatus used in the radio communication system according to a second embodiment;

FIG. 13 illustrates exemplary operation control processing in the radio communication apparatus used in the radio communication system according to a second embodiment;

FIG. 14 illustrates an exemplary transmission processing in the radio communication apparatus used in the radio communication system according to a second embodiment;

FIG. 15 illustrates an exemplary reception processing in the radio communication apparatus used in the radio communication system according to a second embodiment;

FIG. 16 illustrates exemplary communication processing in the radio communication system according to a second embodiment;

FIG. 17 illustrates an operation interval setting method in the radio communication system according to a fourth embodiment;

FIG. 18 illustrates an exemplary operation interval setting method in the radio communication system according to a fourth embodiment;

FIG. 19 illustrates an exemplary operation mode determination processing in the radio tag used in the radio communication system according to a fourth embodiment;

FIG. 20 illustrates an exemplary operation mode determination processing in the radio communication apparatus used in the radio communication system according to a fourth embodiment; and

FIG. 21 illustrates exemplary communication processing in the radio communication system according to a fourth embodiment.

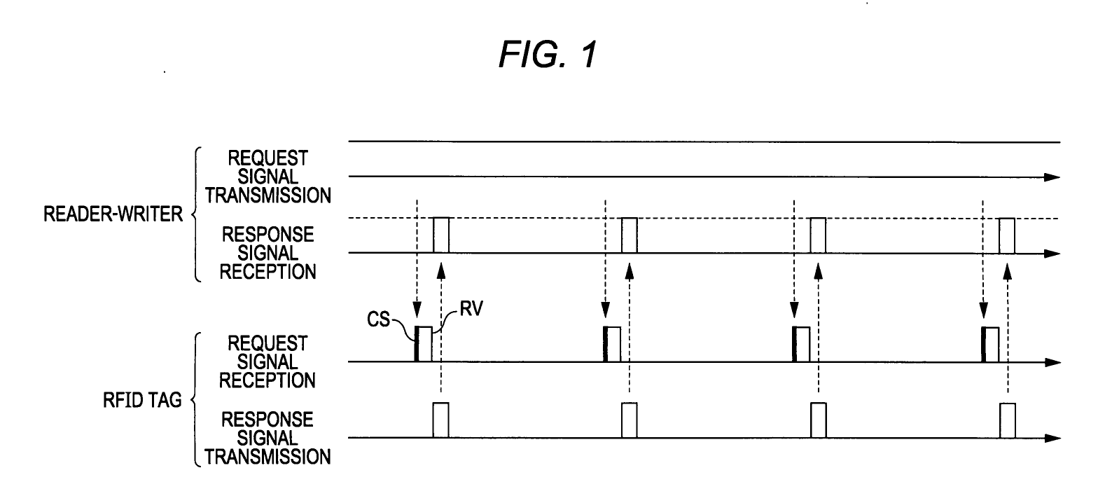

### DETAILED DESCRIPTION OF THE EMBODIMENTS

Electric power saving is required in various systems. However, conventional reader-writers which continuously transmit a request signal have a disadvantage of a large electric power consumption. In particular, a demand for a reader-writer using a battery as a power source has increased. When the electric power of the battery of the reader-writer is consumed in a short time, taken as the whole system, there is a concern that the operation time in battery unit is reduced. An aspect of the embodiments is to provide a radio communication system, which realizes the suppression of electric power consumption by intermittent transmission of a response request transmitted from a reader-writer, and a radio communication apparatus used in the radio communication system.

The radio communication system provided by the embodiments includes a radio communication apparatus, which has a communication part which transmits a request signal requesting a response to a radio tag, and the radio tag which transmits a response signal illustrating a response to the request signal from the radio communication apparatus. The radio communication apparatus further has an intermittent control part which makes the communication part transmit the request signal at an interval of a set stop time during a set operation time. A radio communication system according to an embodiment exerts excellent effects such as the realization of suppression of electric power consumption per unit time in the radio communication apparatus.

In particular, when the radio communication apparatus uses a battery as a power source, the radio communication system exerts excellent effects such as the realization of extending the operation time of the entire system in battery unit.

Hereinafter, the invention is described in detail based on the drawings illustrating the embodiments.

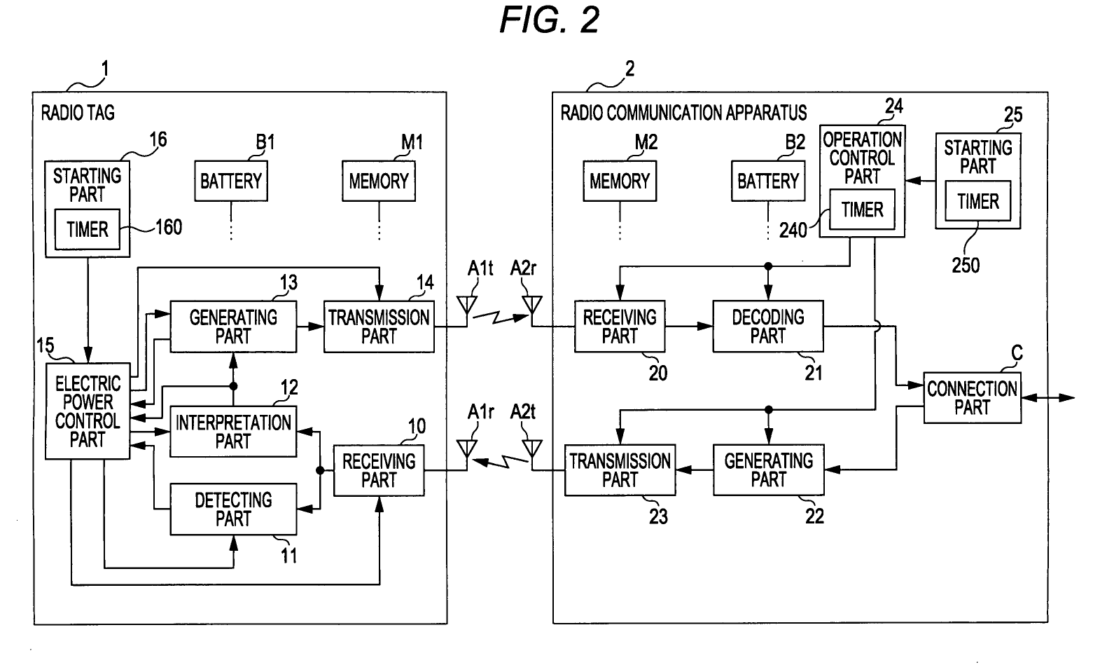

FIG. 2 illustrates a radio communication system according to a first embodiment. The element 1 illustrated in FIG. 2 is an active-type radio tag (RFID tag) used in the radio communication system, and the radio tag 1 performs radio communication with a radio communication apparatus 2 such as a reader-writer. Namely, the radio tag 1 is a kind of such radio communication apparatuses.

A battery B1 as a power supply may be included in the radio tag 1. The radio tag 1 is operated by an electric power supplied from the battery B1. The radio tag 1 includes a memory M1 for storing control programs and data, which include identification information for identifying the radio tag 1 itself.

The radio tag 1 includes a receiving part 10 for receiving a signal through a reception antenna A1r, a detecting part 11 for detecting whether the receiving part 10 has received a signal, and an interpretation part 12 for interpreting data according to the signal received by the receiving part 10. The radio tag 1 includes a generating part 13 for generating data to be transmitted and a transmission part 14 for transmitting as a signal the data, generated by the generating part 13, through a transmission antenna A1t. The radio tag 1 includes as a communication part the reception antenna A1r, the receiving part 10, the detecting part 11, the transmission antenna A1t, and the transmission part 14.

The radio tag 1 includes an electric power control part 15 for controlling an electric power supplied to the receiving part 10, the detecting part 11, the interpretation part 12, the generating part 13, and the transmission part 14, and a starting part 16 for starting the electric power control part 15. The starting part 16 has a timer 160 and intermittently starts the electric power control part 15 at a given time interval timed by the timer 160. The electric power control part 15 and the starting part 16 may operate as an intermittent control part for intermittently controlling each part associated with the signal reception and each part associated with the signal transmission.

The above respective parts provided in the radio tag 1 may be mounted as hardware circuit, or may be mounted as software operated by execution of the control program stored in the memory M1.

A battery B2 as an electric power source may be included in the radio communication apparatus 2. The radio communication apparatus 2 is operated by the electric power supplied from the battery B2. The radio communication apparatus 2 includes a memory M2 for storing control programs and various data. The radio communication apparatus 2 includes a connection part C, such as a connector and a connection circuit which can be connected to a host computer (not illustrated). The radio communication apparatus 2 transmits and receives information to and from the connected host computer when being connected to the host computer.

The radio communication apparatus 2 includes, as the components associating with a reception processing, a receiving part 20 for receiving a signal through a reception antenna A2r and a decoding part 21 for decoding the signal received by the receiving part 20 into processable data. The radio communication apparatus 2 includes, as the components associating with a transmission processing, a generating part 22 for generating data to be transmitted and a transmission part 23 for transmitting as a signal the data, generated by the generating part 22, through a transmission antenna A2t. The radio communication apparatus 2 has, for communication, the reception antenna A2r, the receiving part 20, the transmission antenna A2t, and the transmission part 23.

The radio communication apparatus 2 includes an operation control part 24 for controlling the operation of the receiving part 20, the decoding part 21, the generating part 22, and the transmission part 23, and a starting part 25 for starting the operation control part 24. The starting part 25 has a timer 250 and intermittently starts the operation control part 24 at a given time interval timed by the timer 250. The operation control part 24 has a timer 240. After the operation control part 24 is started, it starts the operation of the receiving part 20, the decoding part 21, the generating part 22, and the transmission part 23. After the operation for a given time timed by the timer 240, the operation control part 24 stops these parts, and also stops itself. Alternatively, the starting part 25 may be incorporated into the operation control part 24, and the operation control part 24 may be always on operation and start or stop the receiving part 20, the decoding part 21, the generating part 22, and the transmission part 23 based on a time timed by the timer 240. The operation control part 24 and the starting part 25 operate as an intermittent control part for intermittently controlling each part associated with the signal reception and each part associated with the signal transmission.

The above respective parts provided in the radio communication apparatus 2 may be mounted as hardware circuit, or may be mounted as software operated by execution of the control program recorded in the memory M2.

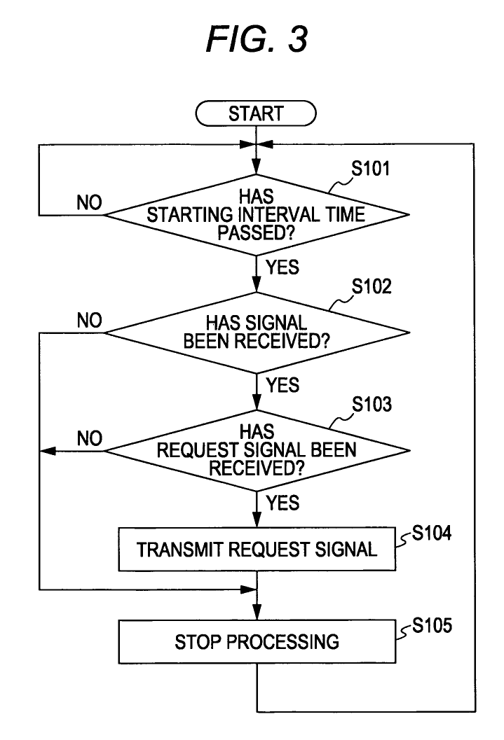

FIG. 3 illustrates an exemplary communication processing in the radio tag 1 used in the radio communication system according to a first embodiment. The starting part 16 in the radio tag 1 compares a time timed by the timer 160 with, for example, a given starting interval stored in given the memory M1, determines whether the time set as the starting interval has passed from the previous start (S101).

In operation S101, when the starting part 16 in the radio tag 1 determines that the time set as the starting interval has passed (S101: YES), the starting part 16 outputs a starting signal to the electric power control part 15.

In operation S101, when the starting part 16 determines that the time set as the starting interval has not passed (S101: NO), the processing returns to operation S101, where the starting part 16 performs the same determination again.

The electric power control part 15 receives the starting signal from the starting part 16, outputs a starting signal to the receiving part 10 and the detecting part 11, and starts power feeding to the receiving part 10 and the detecting part 11.

The detecting part 11 supplied with power detects whether the receiving part 10 receives a signal (radio signal) through the reception antenna A1r.

The detecting part 11 outputs a detection result signal, specifying whether the reception of the signal (radio signal) is detected, to the electric power control part 15.

The electric power control part 15 receives the detection result signal from the detecting part 11, determines whether the signal (radio signal) is received by the receiving part 10 based on the detection result signal (S102).

In operation S102, when the electric power control part 15 determines that the signal is received by the received part 10 (S102: YES), the electric power control part 15 outputs a starting signal to the interpretation part 12 and starts the power feeding to the interpretation part 12.

The interpretation part 12 supplied with power interprets the signal received by the receiving part 10 through the reception antenna A1r, and outputs interpretation result information, including the result of the interpretation, to the electric power control part 15 and the generating part 13.

The electric power control part 15 receives the interpretation result information from the interpretation part 12, determines whether the result of the interpretation included in the interpretation result information is a request for a response transmitted from the radio communication apparatus 2, based on the interpretation result information. Namely, the electric power control part 15 determines whether the request signal requesting a response is received (S103).

In operation S103, when the electric power control part 15 determines that the request signal is received (S103: YES), the electric power control part 15 outputs a starting signal to the generating part 13 and the transmission part 14 and starts power feeding to the generating part 13 and the transmission part 14.

The generating part 13 supplied with the power generates data, which will be transmitted as the result of the interpretation, that is, as the response to the request, based on the interpretation result information received from the interpretation part 12. The generating part 13 outputs the generated data to the transmission part 14 in order to transmit the data. After the data is transmitted, the generating part 13 further outputs a transmission completion signal, specifying the completion of the transmission, to the electric power control part 15.

The transmission part 14 receives the data to be transmitted as the response, transmits the received data as the response signal to the radio communication apparatus 2 through the transmission antenna A1t (S104). The identification information read from the memory M1 is appended to the response signal transmitted in operation S104.

The electric power control part 15 receives the transmission completion signal from the generating part 13, outputs a stop signal to each part started by the starting signal, and then performs a stop processing for stopping the power feeding to each part and stopping its own operation (S105).

When it is determined that the signal is not received by the receiving part 10 in operation S102 (S102: NO), or when it is determined that the received signal is not the request signal based on the interpretation result and that the request signal is not received in operation S103 (S103: NO), the processing proceeds to operation S105 where the electric power control part 15 performs the stop processing (S105).

After the stop processing may be performed in operation S105, the processing returns to operation S101, and the processing of S101 and subsequent operations is repeated in the radio tag 1. As described above, in the radio tag 1, the presence of the reception of the request signal is intermittently detected at a given starting interval, and when the reception of the request signal is detected, the communication processing for transmitting the response signal may be performed.

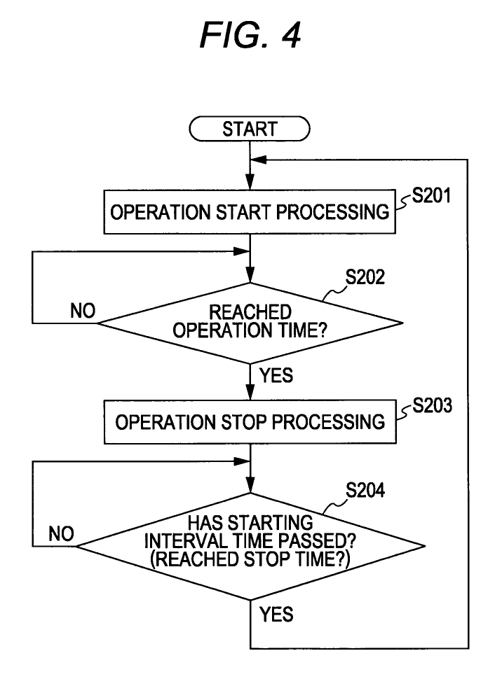

FIG. 4 illustrates exemplary intermittent processing in the radio communication apparatus 2 used in the radio communication system according to a first embodiment. The radio communication apparatus 2 is started upon receipt of, for example, an operation by an operator. After being started, the starting part 25 in the radio communication apparatus 2 outputs a starting signal to the operation control part 24.

The operation control part 24, which receives the starting signal and then is started, outputs an operation start signal to the receiving part 20, the decoding part 21, the generating part 22, and the transmission part 23 to thereby perform an operation start processing for starting the transmission processing for transmitting the request signal requesting a response to the radio tag 1 and the reception processing for receiving the response signal to the request (S201).

The operation control part 24 compares a time timed by the timer 240 with, for example, a given operation time given stored in the memory M2 to thereby determine whether the time from the start of the transmission processing and the reception processing has reached the operation time (S202).

In operation S202, when it is determined that the time from the start of the transmission processing and the reception processing has reached the operation time (S202: YES), the operation control part 24 outputs an operation stop signal to the receiving part 20, the decoding part 21, the generating part 22, and the transmission part 23 to thereby perform operation stop processing for stopping the transmission processing and the reception processing and stopping its own operation (S203).

In operation S202, when it is determined that the time from the start of the transmission processing and the reception processing has not reached the operation time (S202: NO), the processing returns to operation S202, where the operation control part 24 performs the same determination again.

The starting part 25 compares a time timed by the timer 250 with, for example, a given starting interval stored in given the memory M2 to thereby determine whether the time set as the starting interval has passed from the previous output of the starting signal (S204). The starting interval used for the determination in operation S204 is longer than the operation time. The difference between the starting interval and the operation time is defined as a stop time. Thus, the processing in operation S204 can be regarded as the determination whether the time from the stop of the transmission processing and the reception processing has reached the stop time.

In operation S204, when it is determined that the time set as the starting interval has passed, that is, when it is determined that the time has reached the stop time (S204: YES), the starting part 25 outputs the starting signal to the operation control part 24. The processing of operation S201 and subsequent operations is then repeated.

In operation S204, when it is determined that the time has not reached the stop time (S204: NO), the processing returns to operation S204, where the starting part 25 performs the same determination again. The radio communication apparatus 2 performs an intermittent processing of repeating the processing for making the corresponding parts perform the transmission processing and the reception processing during the operation time and stopping the transmission processing and the reception processing during the stop time. Namely, the intermittent processing is a processing for making the corresponding parts transmit the request signal at a given pause time interval during a given operation time.

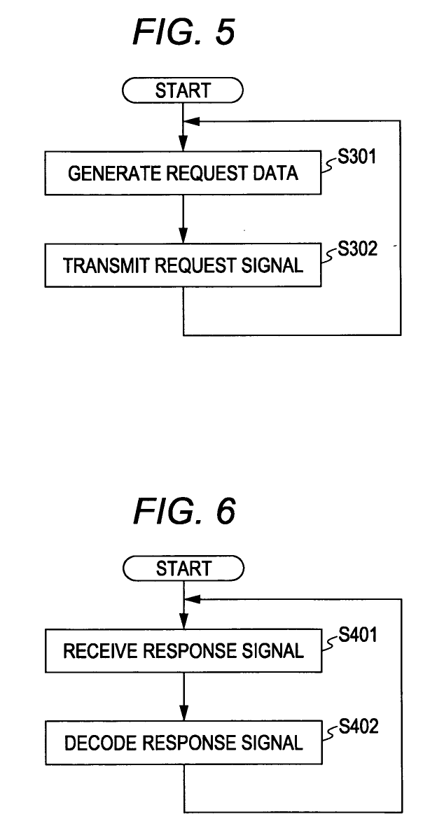

FIG. 5 is a flow chart illustrating an example of the transmission processing in the radio communication apparatus 2 used in the radio communication system according to a first embodiment. The generating part 22 and the transmission part 23 in the radio communication part 2 receive the operation start signal, and then start the transmission processing. The generating part 22 generates data requesting a response based on the instruction from, for example, a host computer (S301) and outputs the generated data to the transmission part 23 in order to transmit the data.

The transmission part 23 receives, from the generating part 22, the data to be transmitted as a request, transmits the received data as the request signal to the radio tag 1 through the transmission antenna A2t (S302). The generating part 22 and the transmission part 23 then repeatedly perform the transmission processing for generating data and transmitting the generated data as the request signal until the generating part 22 and the transmission part 23 receive the operation stop signal.

FIG. 6 illustrates an exemplary reception processing in the radio communication apparatus 2 used in the radio communication system according to a first embodiment. The receiving part 20 and the decoding part 21 in the radio communication apparatus 2 start the reception processing upon receipt of an operation start signal. The receiving part 20 stands by for receiving the response signal indicating a response to a request. The receiving part 20 receives the response signal through the reception antenna A2r (S401), outputs the received response signal to the decoding part 21 (S401). The decoding part 21 receives the response signal from the receiving part 20, decodes the received response signal (S402). The decoding part 21 outputs the content of the response obtained by decoding the response signal to, for example, the host computer. When the received signal is not the response signal, a processing corresponding to the received signal may be performed. Until the operation stop signal is received, the receiving part 20 and the decoding part 21 repeatedly perform the reception processing of waiting for the reception of the response signal, receiving the response signal, and decoding the received response signal.

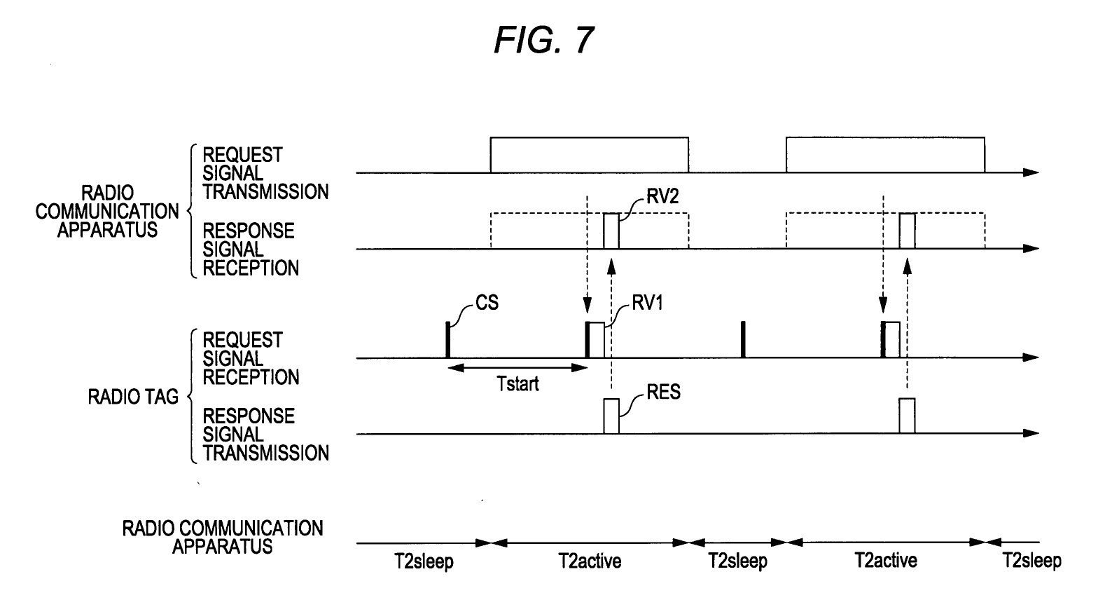

A timing of processing between the components used in the radio communication system according to a first embodiment is described. FIG. 7 illustrates exemplary communication processing in the radio communication system according to a first embodiment. In the time chart illustrated in FIG. 7, the transmission of the request signal and the reception of the response signal in the radio communication apparatus 2, the reception of the request signal and the transmission of the response signal in the radio tag 1, a mode in the radio communication apparatus 2 are illustrated in sequence from the top. Time is illustrated in the horizontal direction, and the communication processing is illustrated in time series. In the chart of the reception of the response signal in the radio communication apparatus 2 illustrated in FIG. 7, boxes illustrated by dashed lines illustrate that the radio communication apparatus 2 waits for receiving the response signal, and boxes illustrated by solid lines illustrate that the radio communication apparatus 2 performs the reception processing.

As illustrated in FIG. 7, the radio communication apparatus 2 performs an intermittent processing of transmitting the request signal during an active time T2active and stopping the transmission of the request signal during a sleep time T2sleep. The radio communication apparatus 2 stands by for receiving the response signal during the active time T2active, and receives the response signal as illustrated as RV2 (Receive) in FIG. 7.

As illustrated in FIG. 7, the radio tag 1 intermittently detects the presence of the request signal at a timing of CS (Career sense). The timing of CS is caused periodically at a starting interval Tstart. When the radio tag 1 detects the request signal, the radio tag 1 receives the request signal illustrated as RV1 in FIG. 7. The radio tag 1 transmits the response signal, illustrated as RES (Response) in FIG. 7, in response to the reception of the request signal.

In the radio communication system according to a first embodiment, the active time T2active in the radio communication apparatus 2 is set so as to be longer than the starting interval Tstart in the radio tag 1. For example, when the starting interval Tstart in the radio tag 1 is 5 seconds, the active time T2active in the radio communication apparatus 2 is set to 10 seconds. In this case, the radio communication apparatus 2 can receive the response once or twice during an active time T2active.

As described above, in the radio communication system according to a first embodiment, the radio communication apparatus 2 performs the transmission processing and the reception processing not continuously but intermittently, whereby the electric power consumption of the battery B2 in the radio communication apparatus 2 can be reduced, and the operation time of the entire system can be extended.

In a second embodiment, the radio tag and the radio communication apparatus in a first embodiment perform the continuous processing and the intermittent processing by suitably switching between these processings. The same components as those in a first embodiment are assigned with the same reference numbers, and a first embodiment is referred to for description thereof. Therefore, the description of the same components is not repeated.

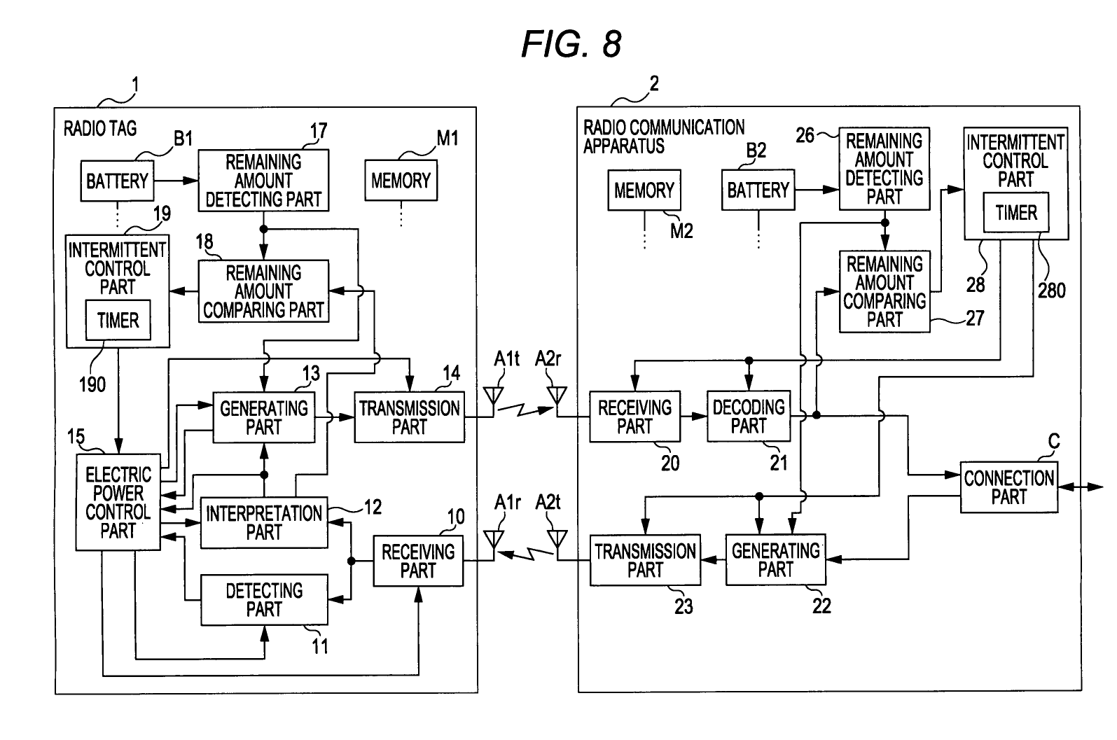

FIG. 8 illustrates a radio communication system according to a second embodiment. The radio tag 1 includes the battery B1, the memory M1, the reception antenna A1r, the transmission antenna A1t, the receiving part 10, the detecting part 11, the interpretation part 12, the generating part 13, the transmission part 14, and the electric power control part 15.

The radio tag 1 includes a remaining amount detecting part 17 for detecting the remaining amount of the electric power in the battery B1, a remaining amount comparing part 18 for comparing the remaining amount of the battery B1 with the remaining amount of the battery B2, and an intermittent control part 19 having a timer 190.

The remaining amount detecting part 17 detects the remaining amount of the electric power in the battery B1, outputs tag battery remaining amount information, indicating the detected remaining amount of the electric power in the battery B1, to the generating part 13 and the remaining amount comparing part 18. In the tag battery remaining amount information, the remaining amount of the electric power in the battery B1 is expressed, for example, in percentage. For example, the remaining amount detecting part 17 detects the remaining amount of the electric power in the battery B1 with the use of voltage, and generates the tag battery remaining amount information based on the result obtained by dividing the detected value by a given voltage value at full charge of the battery B1.

The remaining amount comparing part 18 compares the remaining amount of the battery B1 indicated by the tag battery remaining amount information with a given reference value, outputs comparison result information, indicating the result obtained by the comparison, to the intermittent control part 19. For example, the reference value may be the remaining amount of the electric power in the battery B2. The remaining amount of the electric power in the battery B2 is included in the request signal received from the radio communication apparatus 2 as RW battery remaining amount information indicating the remaining amount of the electric power in the battery B2. In the radio tag 1, the remaining amount of the electric power in the battery B2, which is indicated by the RW battery remaining amount information interpreted by the interpretation part 12, is set as the reference value in the remaining amount comparing part 18. In the RW battery remaining amount information, the remaining amount of the electric power in the battery B2 is expressed, for example, in percentage.

When it is determined that the remaining amount of the battery B1 is not less than the reference value (such as the remaining amount of the battery B2), based on the comparison result information, the intermittent control part 19 controls the electric power control part 15 so that the electric power control part 15 is continuously operated. On the other hand, when it is determined that the remaining amount of the battery B1 is less than the reference value (such as the remaining amount of the battery B2), the intermittent control part 19 controls the electric power control part 15 so that the electric power control part 15 is intermittently operated.

The generating part 13 generates data added with the tag battery remaining amount information, outputs the generated data to the transmission part 14. The response signal added with the tag battery remaining amount information is transmitted, based on the generated data, from the transmission part 14 to the radio communication apparatus 2 through the transmission antenna A1t.

The above respective parts provided in the radio tag 1 may be mounted as hardware circuit, or may be mounted as software operated by execution of the control program recorded in the memory M1.

The radio communication apparatus 2 includes the battery B2, the memory M2, the connection part C, the reception antenna A2r, the transmission antenna A2t, the receiving part 20, the decoding part 21, the generating part 22, and the transmission part 23.

The radio communication apparatus 2 includes a remaining amount detecting part 26 for detecting the remaining amount of the electric power in the battery B2, a remaining amount comparing part 27 for comparing the remaining amount of the battery B1 with the remaining amount of the battery B2, and an intermittent control part 28 having a timer 280. In the radio communication apparatus 2 according to a second embodiment, the intermittent control part 28 intermittently controls the timing of operation in each component associated with the transmission processing and the reception processing.

The remaining amount detecting part 26 detects the remaining amount of the electric power in the battery B2, outputs the RW battery remaining amount information, indicating the detected remaining amount of the electric power in the battery B2, to the generating part 22 and the remaining amount comparing part 27. For example, the remaining amount detecting part 26 detects the remaining amount of the electric power in the battery B2 with the use of voltage, and generates the RW battery remaining amount information based on the result obtained by dividing the detected value by a given voltage value at full charge of the battery B2.

The remaining amount comparing part 27 compares the remaining amount of the battery B2 indicated by the RW battery remaining amount information with a given given reference value, outputs comparison result information, indicating the result obtained by the comparison, to the intermittent control part 28. For example, the reference value may be the remaining amount of the electric power in the battery B1. The remaining amount of the electric power in the battery B1 is included in the response signal as the tag battery remaining amount information. In the radio communication apparatus 2, the remaining amount of the electric power of the battery B1, which is indicated by the tag battery remaining amount information decoded by the decoding part 21, is set as the reference value in the remaining amount comparing part 27.

When it is determined that the remaining amount of the battery B2 is not less than the reference value (such as the remaining amount of the battery B1), based on the comparison result information, the intermittent control part 28 controls the receiving part 20, the decoding part 21, the generating part 22 and the transmission part 23 so that these parts are continuously operated. On the other hand, when it is determined that the remaining amount of the battery B2 is less than the reference value (such as the remaining amount of the battery B1), the intermittent control part 28 controls those parts so that they are intermittently operated.

The generating part 22 generates data added with the RW battery remaining amount information. The request signal added with the RW battery remaining amount information is transmitted, based on the generated data, from the transmission part 23 to the radio tag 1 through the transmission antenna A2t.

The above respective parts provided in the radio communication apparatus 2 may be mounted as hardware circuit, or may be mounted as software operated by execution of the control program recorded in the memory M2.

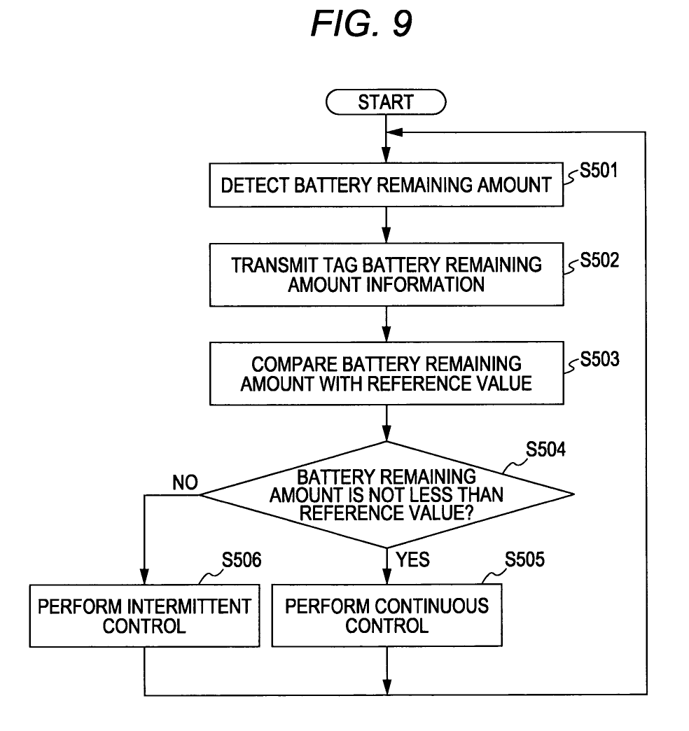

Next, processings in each component used in the radio communication system according to a second embodiment are described in the following. FIG. 9 illustrates exemplary operation mode determination processing in the radio tag 1 used in the radio communication system according to a second embodiment. The radio tag 1 performs the operation mode determination processing for determining whether to operate continuously or intermittently, based on the comparison result of the remaining amount of the battery B1 and the remaining amount of the battery B2. The remaining amount detecting part 17 in the radio tag 1 detects the remaining amount of the electric power in the battery B1 which is the electric power source of the remaining amount detecting part 17 (S501), outputs the tag battery remaining amount information, indicating the detected remaining amount of the electric power in the battery B1, to the generating part 13, and outputs the tag battery remaining amount information to the remaining amount comparing part 18. The generating part 13 receives the tag battery remaining amount information from the remaining amount detecting part 17, generates data added with the tag battery remaining amount information, outputs the generated data to the transmission part 14. The transmission part 14 transmits the response signal added with the tag battery remaining amount information, based on the generated data, to the radio communication apparatus 2 through the transmission antenna A1t. [0089] The remaining amount comparing part 18 receives the tag battery remaining amount information, compares the remaining amount of the battery B1, indicated by the tag battery remaining amount information, with a given reference value (S503). The remaining amount comparing part 18 outputs the comparison result information, indicating the result obtained by the comparison, to the intermittent control part 19. As described above, for example, the given reference value may be the remaining amount of the battery B2 which is the electric power source of the radio communication apparatus 2. Namely, a value where the remaining amount of the battery B1 is expressed in percentage is compared with a reference value where the remaining amount of the battery B2 is expressed in percentage. Alternatively, the value where the remaining amount of the battery B2 is expressed in percentage is not used as the reference value as it is, but a value, which is obtained by multiplying an appropriate coefficient or adding an appropriate constant to the value where the remaining amount of the battery B2 is expressed in percentage, may be used as the reference value. Alternatively, the respective remaining amounts of the battery B1 and the battery B2 may not be expressed in percentage, but they can be suitably set. For example, they can be expressed in voltage values or estimated remaining electrical energy. The reference value may also be set based on the information from the interpretation part 12 received by the remaining amount comparing part 18, as described later, or may be read from the memory M1.

The intermittent control part 19 receives the comparison result information from the remaining amount comparing part 18, determines whether the remaining amount of the battery B1 is not less than the reference value (such as the remaining amount of the battery B2), based on the comparison result illustrated in the comparison result information (S504). In operation S504, when the remaining amount of the battery B1 is not less than the remaining amount of the battery B2 (S504: YES), the intermittent control part 19 performs continuous control for continuously operating the electric power control part 15 (S505). On the other hand, when the remaining amount of the battery B1 is less than the remaining amount of the battery B2 (S504: NO), the intermittent control part 19 performs intermittent control for intermittently operating the electric power control part 15 (S506). The intermittent control part 19 is set in a continuous operation mode when performing the continuous control. The intermittent control part 19 is set in an intermittent operation mode when performing the intermittent control. The processing then returns to operation S501, and the processing of operation S501 and subsequent operations is repeated. The operation mode determination processing may be performed in the radio tag 1.

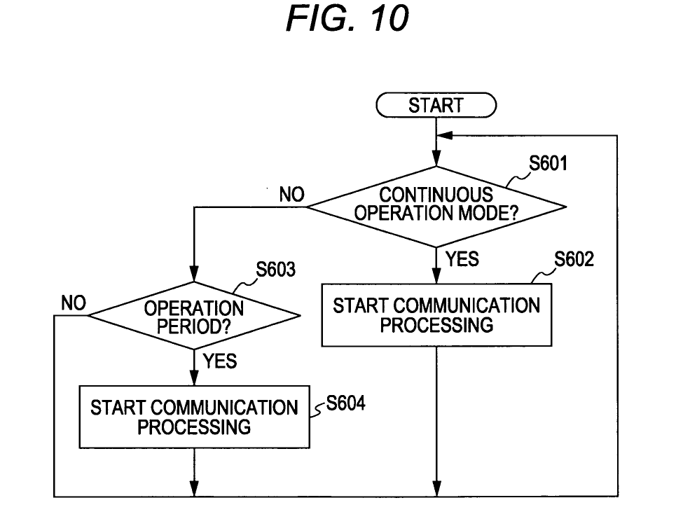

FIG. 10 illustrates exemplary operation control processing in the radio tag 1 used in the radio communication system according to a second embodiment. In the operation control processing, a starting signal is output from the intermittent control part 19 to the electric power control part 15 based on the operation mode, and the operation control processing may be performed in parallel with the operation mode determination processing. The intermittent control part 19 in the radio tag 1 determines whether the operation mode is the continuous operation mode or the intermittent operation mode (S601).

In operation S601, when it is determined that the operation mode is the continuous operation mode (S601: YES), the intermittent control part 19 outputs a starting signal to the electric power control part 15 to thereby start the communication processing (S602). The processing returns to operation S601, and the processing for determining the operation mode is repeated.

In operation S601, when it is determined that the operation mode is the intermittent operation mode (S601: NO), the intermittent control part 19 refers to a time timed by the timer 190, and determines whether the radio tag 1 is in an operation period during which the communication processing may be performed or in a stop period during which the communication processing is stopped (S603). For example, when the operation mode is switched from the continuous operation mode to the intermittent operation mode, the radio tag 1 is in the stop period for a given stop time of, for example, 55 seconds set in the memory M1. After the stop time has elapsed, the radio tag 1 is in the operation period for a given operation time of, for example, 5 seconds. Then, after the operation time has elapsed, the radio tag 1 is again in the stop period during the stop time. This operation/stop setting processing is repeated. Namely, when the intermittent control part 19 determines that the radio tag 1 is in the intermittent operation mode, the intermittent control part 19 performs the intermittent control for performing communication at an interval of the set stop time during the set operation time.

In operation S603, when it is determined that the radio tag 1 is in the operation period (S603: YES), the intermittent control part 19 outputs a starting signal to the electric power control part 15 to thereby start the communication processing (S604). The processing then returns to operation S601, and the processing for determining the operation mode is repeated.

In operation S603, when it is determined that the radio tag 1 is in the stop period (S603: NO), the processing returns to operation S601, and the processing of operation S601 and subsequent operations is repeated in the radio tag 1. The radio tag 1 performs the operation control processing.

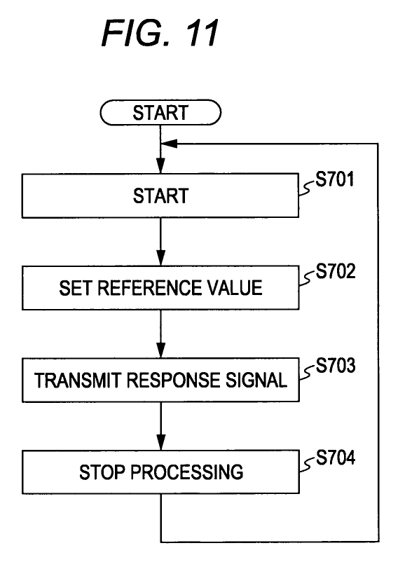

FIG. 11 illustrates an exemplary communication processing in the radio tag 1 used in the radio communication system according to a second embodiment. The communication processing may be performed in parallel with the operation mode determination processing and the operation control processing. The communication processing in the radio tag 1 according to a second embodiment is substantially similar to the communication processing in the radio tag 1 according to a first embodiment; therefore, the description of the processing similar to a first embodiment is described only briefly. The electric power control part 15 in the radio tag 1 starts upon receipt of the starting signal from the intermittent control part 19 (S701) and outputs a starting signal to the receiving part 10 and the detecting part 11 to start the power feeding thereto.

When the electric power control part 15 determines that the signal is received based on the detection result signal from the detecting part 11, the electric power control part 15 outputs a starting signal to the interpretation part 12 to start the power feeding thereto.

The interpretation part 12 supplied with power interprets the signal received by the receiving part 10 through the reception antenna A1r. When the RW battery remaining amount information, which indicates the remaining amount of the battery B2 as the electric power source of the radio communication apparatus 2, is included in the interpretation result, the remaining amount of the battery B2 based on the RW battery remaining amount information is set as the reference value compared in the remaining amount comparing part 18 (S702). The setting of the reference value in operation S702 may be performed as processing such as outputting the RW battery remaining amount information to the remaining amount comparing part 18 and recording the same to the memory M1. Further, the interpretation part 12 outputs the interpretation result information, illustrating the result obtained by interpretation, to the electric power control part 15 and the generating part 13.

When the electric power control part 15 determines that the request signal is received based on the interpretation result information from the interpretation part 12, the electric power control part 15 outputs a starting signal to the generating part 13 and the transmission part 14 to start the power feeding thereto.

The generating part 13 supplied with the power generates data to be transmitted as a response including the tag battery remaining amount information, and outputs the generated data including the tag battery remaining amount information to the transmission part 14. The transmission part 14 transmits the generated data as the response signal to the radio communication apparatus 2 through the transmission antenna A1t (S703). The tag battery remaining amount information transmitted in operation S703 is the information received from the remaining amount detecting part 17. Alternatively, the remaining amount detecting part 17 may record the tag battery remaining amount information in the memory M1, and the generating part 13 may generate data based on the tag battery remaining amount information read from the memory M1.

After the transmission of the response signal is completed, when the signal is not received, or when the request signal is not received, the electric power control part 15 performs the stop processing for stopping the power feeding to each part and stopping its own operation (S704). The processing then returns to operation S701, and the processing of operation S701 and subsequent operations is repeated. The communication processing may be performed in the radio tag 1.

The operation control processing and the communication processing described above are an example, and these processings can be developed into various modes as long as whether the radio tag 1 is in the continuous operation mode or the intermittent operation mode is determined based on the comparison between the battery remaining amounts and the processing for repeating the operation period and the stop period in the intermittent operation mode may be performed. Various processings can be developed, for example, in such a manner that the electric power control part 15 starts in the intermittent operation mode, and the operation time and the stop time are managed by the control by the electric power control part 15, whereby the communication processing is continuously performed during the operation time.

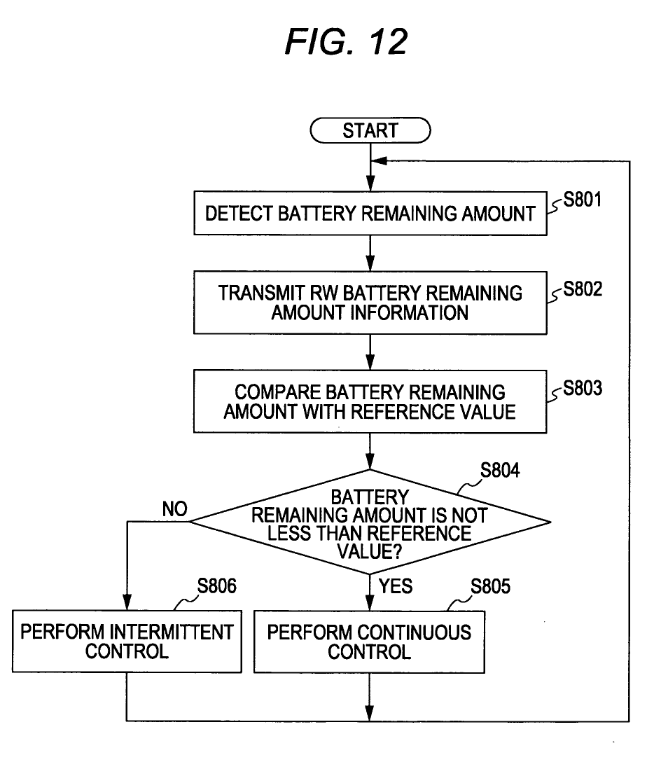

FIG. 12 illustrates exemplary operation mode determination processing in the radio communication apparatus 2 used in the radio communication system according to a second embodiment. The radio communication apparatus 2 performs the operation mode determination processing for determining whether to operate continuously or intermittently based on the comparison result between the remaining amount of the battery B1 and the remaining amount of the battery B2. The remaining amount detecting part 26 in the radio communication apparatus 2 detects the remaining amount of the electric power in the battery B2 which is the electric power source of the radio communication apparatus 2(S801), outputs the RW battery remaining amount information, indicating the detected remaining amount of the electric power in the battery B2, to the generating part 22, to thereby make the generating part 22 and the transmission part 23 perform a processing for transmitting the RW battery remaining amount information (S802). The remaining amount detecting part 26 outputs the RW battery remaining amount information to the remaining amount comparing part 27.

The remaining amount comparing part 27 in receipt of the RW battery remaining amount information compares the remaining amount of the battery B2, indicated by the RW battery remaining amount information, with a given reference value (S803) to output comparison result information, indicating the result obtained by the comparison, to the intermittent control part 28. The given reference value may be the remaining amount of the electric power of the battery B1 which is the electric power source of the radio tag 1. Namely, a value where the remaining amount of the battery B2 is expressed in percentage is compared with a reference value where the remaining amount of the battery B1 is expressed in percentage. Alternatively, the value where the remaining amount of the battery B1 is expressed in percentage is not used as the reference value as it is, but, for example, a value, which is obtained by multiplying an appropriate coefficient or by subtracting an appropriate constant with respect to the value where the remaining amount of the battery B1 is expressed in percentage, may be used as the reference value. The reference value may also be set based on the information from the decoding part 21 received by the remaining amount comparing part 27, as described later, or may be read from the memory M2.

When the remaining amount of the battery B2 is not less than the reference value (such as the remaining amount of the battery B1), based on the comparison result included in the comparison result information (S804: YES), the intermittent control part 28 in receipt of the comparison result information performs continuous control for continuously operating the receiving part 20, the decoding part 21, the generating part 22, and the transmission part 23 (S805). On the other hand, when the remaining amount of the battery B2 is less than the remaining amount of the battery B1 (S804: NO), the intermittent control part 28 performs intermittent control for intermittently operating the receiving part 20, the decoding part 21, the generating part 22, and the transmission part 23 (S806). The intermittent control part 28 is set in a continuous operation mode when performing the continuous control, and the intermittent control part 28 is set in an intermittent operation mode when performing the intermittent control. The processing then returns to operation S801, and the processing of operation S801 and subsequent operations is repeated in the radio communication apparatus 2. The radio communication apparatus 2 performs the operation mode determination processing.

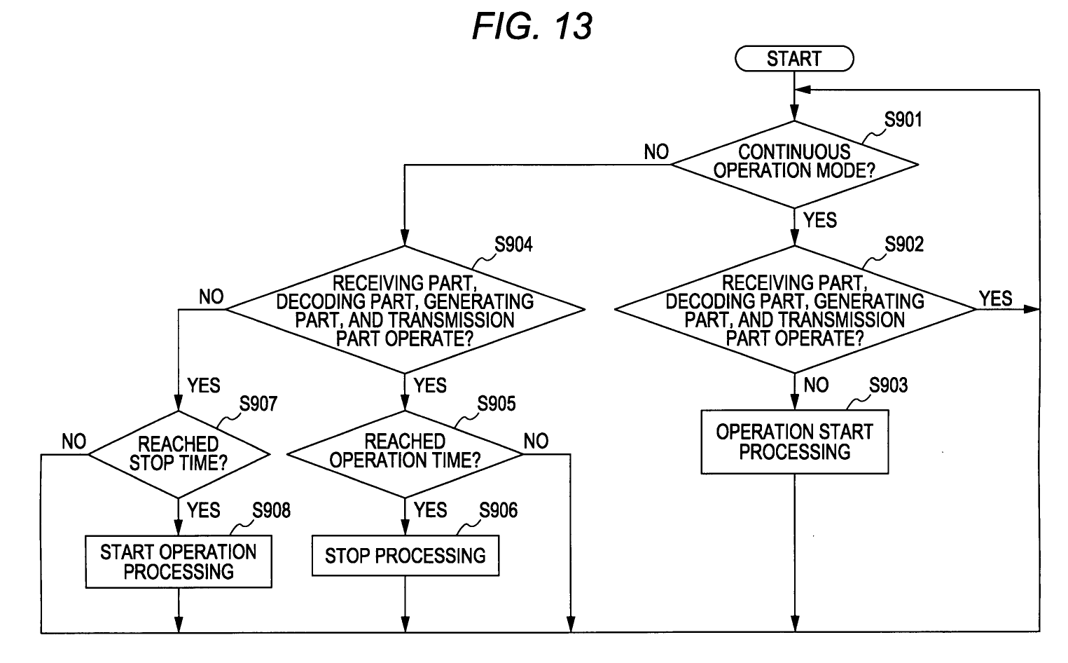

FIG. 13 illustrates exemplary operation control processing in the radio communication apparatus 2 used in the radio communication system according to a second embodiment. In the operation control processing, the intermittent control part 28 controls the receiving part 20, the decoding part 21, the generating part 22, and the transmission part 23 based on the operation mode, and the operation control processing may be performed in parallel with the operation mode determination processing. The intermittent control part 28 in the radio communication apparatus 2 determines whether the operation mode is the continuous operation mode or the intermittent operation mode (S901).

In operation S901, when it is determined that the operation mode is the continuous operation mode (S901: YES), the intermittent control part 28 determines whether the receiving part 20, the decoding part 21, the generating part 22, and the transmission part 23 are in operation (S902).

In operation S902, when it is determined that those parts are in operation (S902: YES), the processing returns to operation S901, and the intermittent control part 28 repeats the processing of operation S901 and subsequent operations.

In operation S902, when it is determined that those parts are stopped (S902: NO), the intermittent control part 28 outputs an operation start signal to the receiving part 20, the decoding part 21, the generating part 22 and the transmission part 23 to thereby perform an operation start processing for starting a transmission processing for transmitting the request signal requesting a response to the radio tag 1 and a reception processing for receiving the response signal to the request (S903). The processing then returns to operation S901, and the intermittent control part 28 repeats the processing of operation S901 and subsequent operations.

In operation S901, when it is determined that the operation mode is the intermittent operation mode (S901: NO), the intermittent control part 28 determines whether the receiving part 20, the decoding part 21, the generating part 22, and the transmission part 23 are in operation (S904).

In operation S904, when it is determined that those parts are in operation (S904: YES), the intermittent control part 28 refers to the timer 280 to determine whether the time from the start of the transmission processing and the reception processing has reached the given operation time of, for example, 5 seconds stored in the memory M2, for example (S905).

In operation S905, when it is determined that the time has reached the operation time (S905: YES), the intermittent control part 28 outputs an operation stop signal to the receiving part 20, the decoding part 21, the generating part 22, and the transmission part 23 to thereby perform stop processing for stopping the transmission processing and the reception processing (S906). The processing then returns to operation S901, and the intermittent control part 28 repeats the processing of operation S901 and subsequent operations.

In operation S905, when it is determined that the time has not reached the operation time (S905: NO), the processing returns to operation S901, and the intermittent control part 28 repeats the processing of operation S901 and subsequent operations.

In operation S904, when it is determined that those parts are stopped (S904: NO), the intermittent control part 28 refers to the timer 280 to determine whether the time from the stop of the transmission processing and the reception processing has reached the given stop time of, for example, 55 seconds stored in the memory M2, for example (S907).

In operation S907, when it is determined that the time has reached the stop time (S907: YES), the intermittent control part 28 outputs an operation start signal to the receiving part 20, the decoding part 21, the generating part 22, and the transmission part 23 to thereby perform the operation start processing for starting the transmission processing and the reception processing (S908). The processing then returns to operation S901, and the intermittent control part 28 repeats the processing of operation S901 and subsequent operations.

In operation S907, when it is determined that the time has not reached the stop time (S907: NO), the processing returns to operation S901, the intermittent control part 28 repeats the processing of operation S901 and subsequent operations. The radio communication apparatus 2 performs the operation control processing.

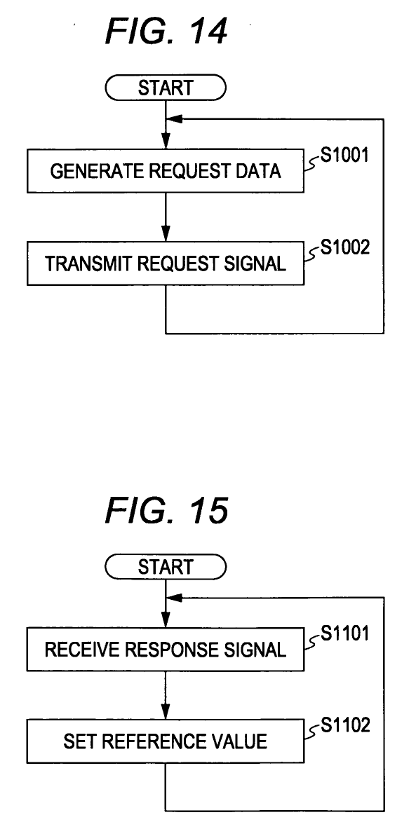

FIG. 14 illustrates an exemplary transmission processing in the radio communication apparatus 2 used in the radio communication system according to a second embodiment. The generating part 22 generates data, including the RW battery remaining amount information and requesting a response, based on, for example, an instruction from a host computer and the RW battery remaining amount information from the remaining amount detecting part 26 (S1001) to output the generated data including the RW battery remaining amount information to the transmission part 23 in order to transmit the data.

The transmission part 23 transmits the generated data including the RW battery remaining amount information as the request signal to the radio tag 1 through the transmission antenna A2t (S1002). The generating part 22 and the transmission part 23 repeatedly perform the transmission processing of generating data and transmitting the generated data as the request signal until receiving the operation stop signal. The RW battery remaining amount information transmitted in operation S1002 is the information received from the remaining amount detecting part 26. The remaining amount detecting part 26 may record the RW battery remaining amount information in the memory M2, and the generating part 22 may generate the data based on the RW battery remaining amount information read from the memory M2.

FIG. 15 illustrates an exemplary reception processing in the radio communication apparatus 2 used in the radio communication system according to a second embodiment. The receiving part 20 and the decoding part 21 in the radio communication apparatus 2 start the reception processing upon receipt of an operation start signal. The receiving part 20 stands by for receiving the response signal indicating a response to a request. The receiving part 20 receives the response signal through the reception antenna A2r (S1101), and the received response signal is decoded by the decoding part 21. When the decoded response signal includes the tag battery remaining amount information indicating the remaining amount of the battery B1 which is the electric power source of the radio tag 1, the remaining amount of the battery B1 based on the tag battery remaining amount information is set as a reference value compared in the remaining amount comparing part 27 (S1102). The setting of the reference value in operation S1102 may be performed as processing such as outputting the tag battery remaining amount information to the remaining amount comparing part 27 and recording the same to the memory M2. Further, the decoding part 21 outputs the contents of the response, obtained by decoding the response signal, to, for example, the host computer. The receiving part 20 and the decoding part 21 wait for the reception of the response signal and repeatedly perform the reception processing for receiving and decoding the response signal until receiving the operation stop signal.

The operation mode determination processing, the operation control processing, the transmission processing and the reception processing are an example and these processings can be developed into various modes as long as whether the radio communication apparatus 2 is in the continuous operation mode or the intermittent operation mode is determined based on the comparison between the battery remaining amounts, and a processing for repeating an operation period and a stop period in the intermittent operation mode may be performed.

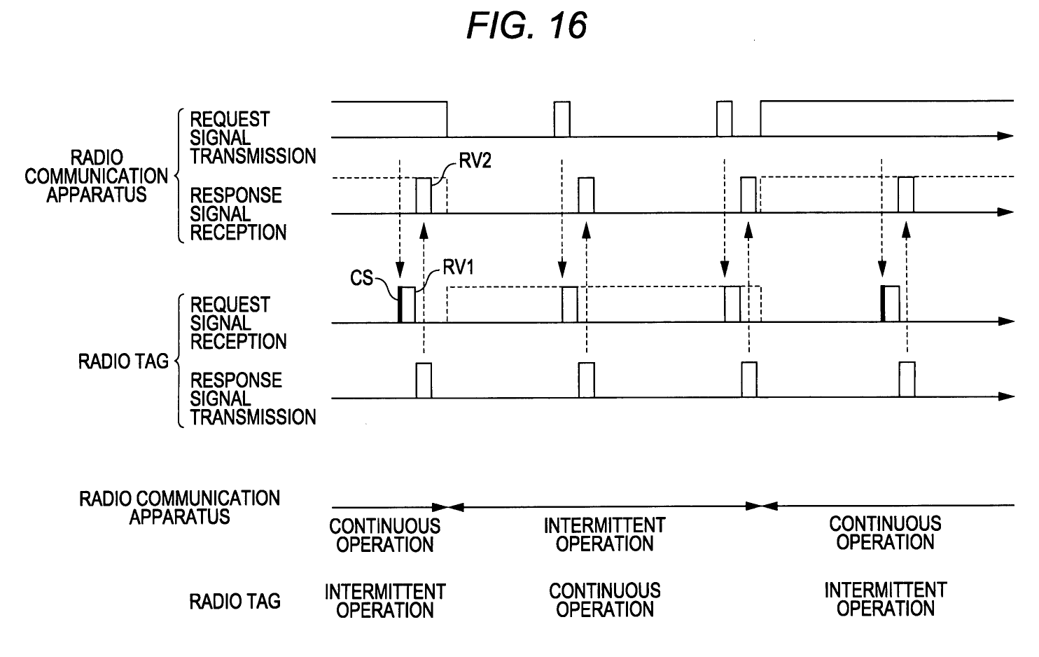

Next, the timing of processing between the components used in the radio communication system according to a second embodiment is described. FIG. 16 illustrates exemplary communication processing in the radio communication system according to a second embodiment. In the time chart of FIG. 16, the transmission of the request signal and the reception of the response signal in the radio communication apparatus 2, the reception of the request signal and the transmission of the response signal in the radio tag 1, the operation modes in the radio communication apparatus 2 and the radio tag 1 are illustrated from the top. Time is illustrated in the horizontal direction, and the communication processing is illustrated in time series. The description in FIG. 16 is based on the description in FIG. 7. In the charts of the reception of the response signal in the radio communication apparatus 2 and the reception of the request signal in the radio tag 1 illustrated in FIG. 16, boxes illustrated by dashed lines illustrate that the radio communication apparatus 2 and the radio tag 1 wait for reception, and boxes illustrated by solid lines illustrate that the radio communication apparatus 2 and the radio tag 1 perform the reception processing. The radio tag 1 which is in the state of waiting for reception continuously detects the presence of the request signal.

As illustrated in FIG. 16, the radio tag 1 and the radio communication apparatus 2 repeatedly perform the continuous operation mode and the intermittent operation mode. While the radio tag 1 is in the continuous operation mode, the radio communication apparatus 2 is in the intermittent operation mode, and while the radio tag 1 is in the intermittent operation mode, the radio communication apparatus 2 is in the continuous operation mode.

As described above, in the radio communication system according to a second embodiment, the radio tag 1 and the radio communication apparatus 2 compare the remaining amounts of their batteries with each other. The one with the smaller remaining amount is in the intermittent operation mode, and the other with the larger remaining amount is in the continuous operation mode. According to the above embodiment, the operation time of the entire system can be extended.

In a third embodiment, the remaining amount of the battery in a second embodiment may be converted into a remaining operable time. The same components as those in the first or second embodiment are assigned with the same reference numbers, and the first and second embodiments are referred to for description thereof. Therefore, the description of the same components is not repeated.

The configuration example of the radio communication system according to a third embodiment is similar to that of a second embodiment. Namely, the radio tag 1 includes the battery B1, the memory M1, the reception antenna A1r, the transmission antenna A1t, the receiving part 10, the detecting part 11, the interpretation part 12, the generating part 13, the transmission part 14, the electric power control part 15, the remaining amount detecting part 17, the remaining amount comparing part 18, and the intermittent control part 19. The radio communication apparatus 2 includes the battery B2, the memory M2, the connection part C, the reception antenna A2r, the transmission antenna A2t, the receiving part 20, the decoding part 21, the generating part 22, the transmission part 23, the remaining amount detecting part 26, the remaining amount comparing part 27, and the intermittent control part 28.

The remaining amount detecting part 17 in the radio tag 1 in a third embodiment detects the remaining amount of the electric power in the battery B1 and converts the detected remaining amount of the electric power in the battery B1 into the remaining operation time. The conversion into the remaining operation time may be performed by dividing the detected remaining amount of the electric power in the battery B1 by the amount of electric power consumption per a set unit time. The amount of electric power consumption per unit time may be stored in the memory M1, for example. Alternatively, an integration value of a consumption current per unit time and a value of, for example, a decrease in the remaining amount of the electric power may be actually measured to adaptively set the amount of electric power consumption per unit time according to the actual measured values.

The remaining amount comparing part 18 in the radio tag 1 compares the remaining operation time in the radio tag 1, converted from the remaining amount of the electric power in the battery B1 with the remaining operation time in the radio communication apparatus 2 set as a reference value.

The remaining amount detecting part 26 in the radio communication apparatus 2 in a third embodiment detects the remaining amount of the electric power in the battery B2 and converts the detected remaining amount of the electric power in the battery B2 into the remaining operation time. The conversion into the remaining operation time may be performed by dividing the detected remaining amount of the electric power in the battery B2 by the amount of electric power consumption per a set unit time. The amount of electric power consumption per unit time may be stored in the memory M2, for example. Alternatively, an integration value of a consumption current per unit time and a value of, for example, a decrease in the remaining amount of the electric power may be actually measured to adaptively set the amount of electric power consumption per unit time according to the actual measured values.

The remaining amount comparing part 27 in the radio communication apparatus 2 compares the remaining operation time in the radio communication apparatus 2, converted from the remaining amount of the electric power in the battery B2 with the remaining operation time in the radio tag 1 set as a reference value.

Since the other configuration and processing are similar to those in a second embodiment, a second embodiment is referred to for description thereof, and the description is not repeated.

In a fourth embodiment, the operation time and the stop time are dynamically changed in accordance with the result obtained by the comparison between the battery remaining amounts in a second embodiment. The same components as those in the first, second, or third embodiment are assigned with the same reference numbers, and the first, second, and third embodiments are referred to for description thereof. Therefore, the description of the same components is not repeated.

The configuration example of the radio communication system according to a fourth embodiment is similar to that of a second embodiment. However, while the remaining amount of the battery B1 and the remaining amount of the battery B2 are compared in a binary manner as to which is larger or smaller in a second embodiment, they are compared in a multivalued manner, as a value such as a difference or a ratio, in a fourth embodiment.

In a fourth embodiment, the radio tag 1 includes the battery B1, the memory M1, the reception antenna A1r, the transmission antenna A1t, the receiving part 10, the detecting part 11, the interpretation part 12, the generating part 13, the transmission part 14, the electric power control part 15, the remaining amount detecting part 17, the remaining amount comparing part 18, and the intermittent control part 19. The radio communication apparatus 2 includes the battery B2, the memory M2, the connection part C, the reception antenna A2r, the transmission antenna A2t, the receiving part 20, the decoding part 21, the generating part 22, the transmission part 23, the remaining amount detecting part 26, the remaining amount comparing part 27, and the intermittent control part 28.

The remaining amount comparing part 18 in the radio tag 1 in a fourth embodiment outputs a result obtained by subtracting the reference value, that is, the remaining amount of the battery B2 from the remaining amount of the battery B1, as the comparison result information to the intermittent control part 19. For example, the remaining amount detecting part 17 outputs the remaining amount of the battery B1 expressed in percentage. When the remaining amount of the battery B1 is 80% and the remaining amount of the battery B2 is 70%, the comparison result information is +10%. When the remaining amount of the battery B1 is 50% and the remaining amount of the battery B2 is 70%, the comparison result information is −20%. In this embodiment, although the difference between the remaining amount of the battery B1 and the remaining amount of the battery B2 is used for comparison, the comparison can be suitably designed in an alternative manner. For example, the remaining amount of the battery B1 may be divided by the remaining amount of the battery B2, whereby the ratio between them may be used for comparison.

The intermittent control part 19 determines the operation mode by a given operation interval setting method based on the comparison result information and controls the electric power control part 15 based on the determined operation mode.

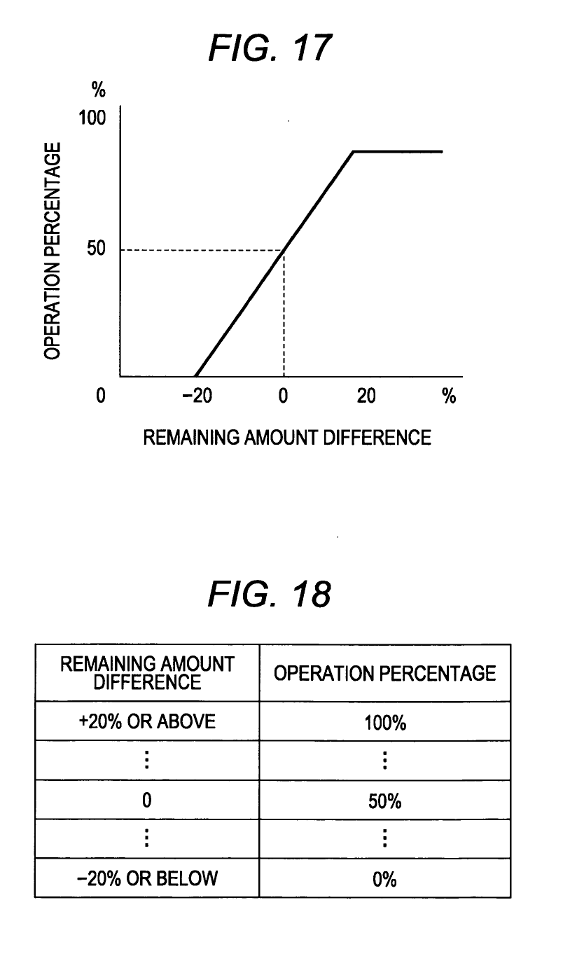

FIG. 17 illustrates an operation interval setting method in the radio communication system according to a fourth embodiment. In FIG. 17, the horizontal axis illustrates the difference between the remaining amount of the battery B1 and the remaining amount of the batter B2 included in the comparison result information, and the vertical axis illustrates the operation percentage, whereby the relation between the remaining amount difference and the operation percentage is indicated. As illustrated in FIG. 17, when the comparison result information is not less than +20%, the operation percentage is 100%. When the comparison result information is less than −20%, the operation percentage is 0%. When the comparison result information is not less than −20% and less than +20%, the operation percentage is 0 to 100%. The graph of FIG. 17 is recorded in a circuit such as the electric control part 15 and the memory M1 as, for example, a mathematical expression.

When the operation percentage is 100%, the radio tag 1 may operate in the continuous operation mode. When the operation percentage is 0%, the radio tag 1 may operate in the intermittent operation mode. In this case, the intermittent operation mode is defined as a state in which the ratio of the operation time to the sum of the operation time and the stop time is fixed at not more than a constant value. In this embodiment, an example in which the operation time is set to 95 seconds and the stop time is fixed at 5 seconds in the intermittent operation mode is described. When the operation percentage is 0 to 100%, the radio tag 1 may operate in a variable operation mode in which the radio tag 1 may operate at the ratio illustrated by the operation percentage. For example, when the operation percentage is 50%, the operation time is set to 50 seconds and the stop time is set to 50 seconds. When the operation percentage is 30%, the operation time is set to 30 seconds and the stop time is set to 70 seconds. However, when the operation percentage is 0 to 5%, the operation time is set to 95 seconds, and the stop time is set to 5 seconds, so that it does not become less than the operation percentage in the intermittent operation mode. Namely, the variable operation mode is a kind of the intermittent operation mode and is an operation mode in which the ratio (percentage) between the operation time and the stop time is dynamically changed.

FIG. 18 illustrates an exemplary operation interval setting method in the radio communication system according to a fourth embodiment. In the table of FIG. 18, the relation between the comparison result information and the operation percentage are associated with each other. In the table of FIG. 18, the graph of FIG. 17 is expressed as a discrete value. The radio tag 1 can also obtain the operation percentage from the comparison result information with the use of the table of FIG. 18 to determine the operation mode.

The remaining amount comparing part 27 in the radio communication system in a fourth embodiment outputs a result obtained by subtracting the reference value (such as the remaining amount of the battery B1) from the remaining amount of the battery B2, as the comparison result information to the intermittent control part 28.

The intermittent control part 28 determines the operation mode by a given operation interval setting method based on the comparison result information and controls the receiving part 20, the decoding part 21, the generating part 22, and the transmission part 23 based on the determined operation mode. The specific method for obtaining the comparison result information and the method for determining the operation mode are similar to the case of the radio tag 1.

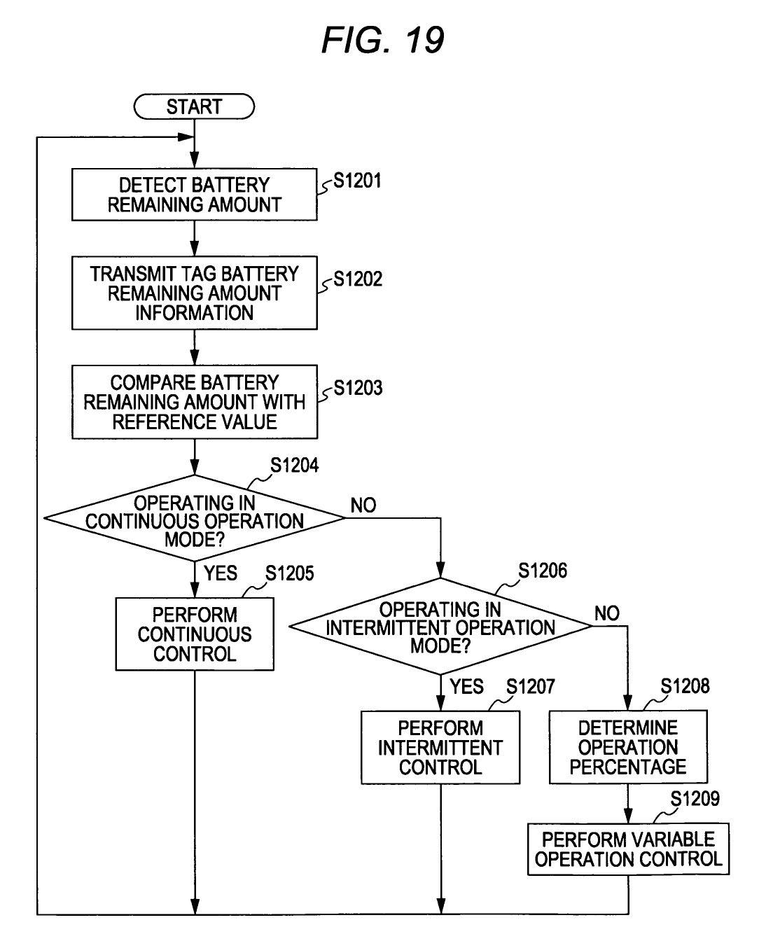

Next, processings in each component used in the radio communication system according to a fourth embodiment are described. FIG. 19 illustrates exemplary operation mode determination processing in the radio tag 1 used in the radio communication system according to a fourth embodiment. The remaining amount detecting part 17 in the radio tag 1 detects the remaining amount of the electric power in the battery B1 (S1201), outputs the tag battery remaining amount information, indicating the detected remaining amount of the electric power in the battery B1, to the generating part 13, to thereby make the generating part 13 and the transmission part 14 perform the processing for transmitting the tag battery remaining amount information (S1202). The remaining amount detecting part 17 outputs the tag battery remaining amount information to the remaining amount comparing part 18.

The remaining amount comparing part 18 in receipt of the tag battery remaining amount information compares the remaining amount of the battery B1 indicated by the tag battery remaining amount information with a given reference value (S1203). The remaining amount comparing part 18 outputs the comparison result information, including the result obtained by the comparison, to the intermittent control part 19. The comparison result information, which includes the result obtained by the comparison in operation S1203, is the information which includes the result obtained by subtracting the reference value from the remaining amount of the battery B1 as described above.

The intermittent control part 19 in receipt of the comparison result information determines whether the electric power control part 15 is to be operated in the continuous operation mode based on the value included in the comparison result information (S1204). The determination in operation S1204 may be performed by using information such as the graph of FIG. 17 and the table of FIG. 18. For example, when the comparison result information is a value of not less than +20%, the electric power control part 15 is to be operated in the continuous operation mode.

In operation S1204, when it is determined that the electric power control part 15 is to be operated in the continuous operation mode (S1204: YES), the intermittent control part 19 applies the continuous control to the electric power control part 15 (S1205). The processing then returns to operation S1201, and the processing of operation S1201 and subsequent operations is repeated.

In operation S1204, when it is determined that the electric power control part 15 is not to be operated in the continuous operation mode (S1204: NO), the intermittent control part 19 determines whether the electric power control part 15 is to be operated in the intermittent operation mode based on the value included in the comparison result information (S1206). The determination in operation S1206 may be performed by using information such as the graph of FIG. 17 and the table of FIG. 18. For example, when the comparison result information is a value of less than −20%, the electric power control part 15 is to be operated in the intermittent operation mode.

In operation S1206, when it is determined that the electric power control part 15 is to be operated in the intermittent operation mode (S1206: YES), the intermittent control part 19 applies the intermittent control to the electric power control part 15 (S1207). The processing then returns to operation S1201, and the processing of operation S1201 and subsequent operations is repeated.

In operation S1206, when it is determined that the electric power control part 15 is not to be operated in the intermittent operation mode (S1206: NO), the intermittent control part 19 determines that the electric power control part 15 is to be operated in the variable operation mode, and determines the operation percentage based on the value included in the comparison result information (S1208). The determination in operation S1208 may be performed by using information such as the graph of FIG. 17 and the table of FIG. 18.

The intermittent control part 19 then performs variable operation control in the variable operation mode based on the determined operation percentage (S1209). The processing then returns to operation S1201, and the processing of operation S1201 and subsequent operations is repeated. The radio tag 1 performs the operation mode determination processing.

Since the operation control processing in the radio tag 1 according to a fourth embodiment is similar to that according to a second embodiment, a second embodiment is referred to for description thereof, and the description is not repeated. When it is determined that the electric power control part 15 is to be operated in the variable operation mode, the processing similar to that in the intermittent operation mode may be performed; however, in the variable operation mode, the control using the operation time and the stop time based on the operation percentage, which is determined in operation S1208 in the operation mode determination processing, may be performed.

Since the communication processing in the radio tag 1 according to a fourth embodiment is similar to that according to a second embodiment, a second embodiment is referred to for description thereof, and the description is not repeated.

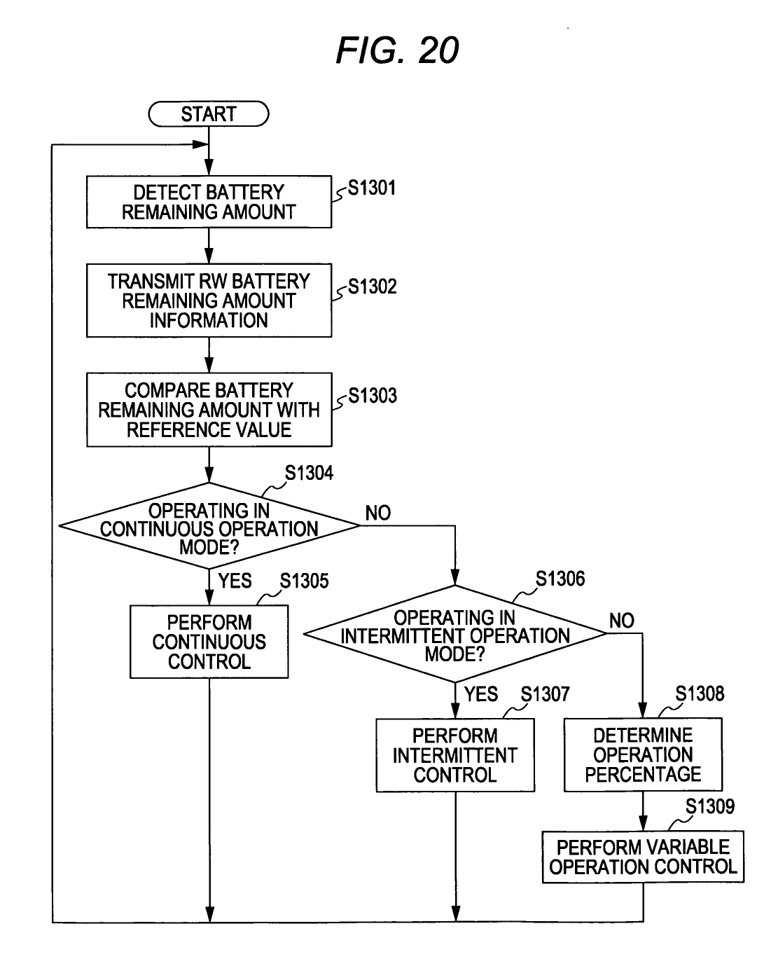

FIG. 20 illustrates an exemplary operation mode determination processing in the radio communication apparatus 2 used in the radio communication system according to a fourth embodiment. The remaining amount detecting part 26 in the radio communication apparatus 2 detects the remaining amount of the electric power in the battery B2 (S1301), outputs the RW battery remaining amount information, indicating the detected remaining amount of the electric power in the battery B2, to the generating part 22, to thereby make the generating part 22 and the transmission part 23 perform the processing for transmitting the RW battery remaining amount information (S1302). The remaining amount detecting part 26 outputs the RW battery remaining amount information to the remaining amount comparing part 27.

The remaining amount comparing part 27 in receipt of the RW battery remaining amount information compares the remaining amount of the battery B2 indicated by the RW battery remaining amount information with a given reference value (S1303). The remaining amount comparing part 27 outputs the comparison result information, including the result obtained by the comparison, to the intermittent control part 28. The comparison result information, which includes the result obtained by the comparison in operation S1303, is the information which includes the result obtained by subtracting the reference value from the remaining amount of the battery B2.

The intermittent control part 28 in receipt of the comparison result information determines whether the receiving part 20, the decoding part 21, the generating part 22, and the transmission part 23 are to be operated in the continuous operation mode based on the value indicated by the comparison result information (S1304). The determination in operation S1304 may be performed by using information such as the graph of FIG. 17 and the table of FIG. 18. For example, when the comparison result information is a value of not less than +20%, the receiving part 20, the decoding part 21, the generating part 22, and the transmission part 23 are to be operated in the continuous operation mode.

In operation S1304, when it is determined that the receiving part 20, the decoding part 21, the generating part 22, and the transmission part 23 are to be operated in the continuous operation mode (S1304:. YES), the intermittent control part 28 applies the continuous control to those parts (S1305). The processing then returns to operation S1301, and the processing of operation S1301 and subsequent operations is repeated.

In operation S1304, when it is determined that the receiving part 20, the decoding part 21, the generating part 22, and the transmission part 23 are not to be operated in the continuous operation mode (S1304: NO), the intermittent control part 28 determines whether those parts are to be operated in the intermittent operation mode based on the value indicated by the comparison result information (S1306). The determination in operation S1306 may be performed by using information such as the graph of FIG. 17 and the table of FIG. 18. For example, when the comparison result information is a value of less than −20%, the receiving part 20, the decoding part 21, the generating part 22, and the transmission part 23 are to be operated in the intermittent operation mode.

In operation S1306, when it is determined that the receiving part 20, the decoding part 21, the generating part 22, and the transmission part 23 are to be operated in the intermittent operation mode (S1306: YES), the intermittent control part 28 applies the intermittent control to those parts (S1307). The processing then returns to operation S1301, and the processing of operation S1301 and subsequent operations is repeated.

In operation S1306, when it is determined that the receiving part 20, the decoding part 21, the generating part 22, and the transmission part 23 are not to be operated in the intermittent operation mode (S1306: NO), the intermittent control part 28 determines that those parts are to be operated in the variable operation mode, and determines the operation percentage based on the value indicated by the comparison result information (S1308). The determination in operation S1308 may be performed by using information such as the graph of FIG. 17 and the table of FIG. 18.

The intermittent control part 28 then performs variable operation control in the variable operation mode based on the determined operation percentage (S1309). The processing then returns to operation S1301, and the processing of operation S1301 and subsequent operations is repeated. The radio communication apparatus 2 performs the operation mode determination processing.

Since the operation control processing in the radio communication apparatus 2 according to a fourth embodiment is similar to that according to a second embodiment, a second embodiment is referred to for description thereof, and the description is not repeated. When it is determined that the receiving part 20, the decoding part 21, the generating part 22, and the transmission part 23 are to be operated in the variable operation mode, the processing similar to that in the intermittent operation mode may be performed; however, in the variable operation mode, the control using the operation time and the stop time based on the operation percentage, which is determined in operation S1308 in the operation mode determination processing, may be performed.

Since the transmission processing and the reception processing in the radio communication apparatus 2 according to a fourth embodiment are similar to those according to a second embodiment, a second embodiment is referred to for description thereof, and the description is not repeated.

When the operation mode in the radio tag 1 and the radio communication apparatus 2 is switched to the variable operation mode based on the graph illustrated in FIG. 17, a state in which one stops while the other may operate may be repeated depending on the timing. Thus, in the variable operation mode, the operation time illustrated in the graph of FIG. 17 can be suitably set at, for example, +5%.

The above various processings are an example, and these processings can be developed into various modes as long as the continuous operation mode, the intermittent operation mode, or the variable operation mode is determined based on the comparison between the battery remaining amounts, the operation percentage is further determined in the variable operation mode, and the processing for repeating the operation period and the stop period in the intermittent operation mode and in the variable operation mode may be performed.

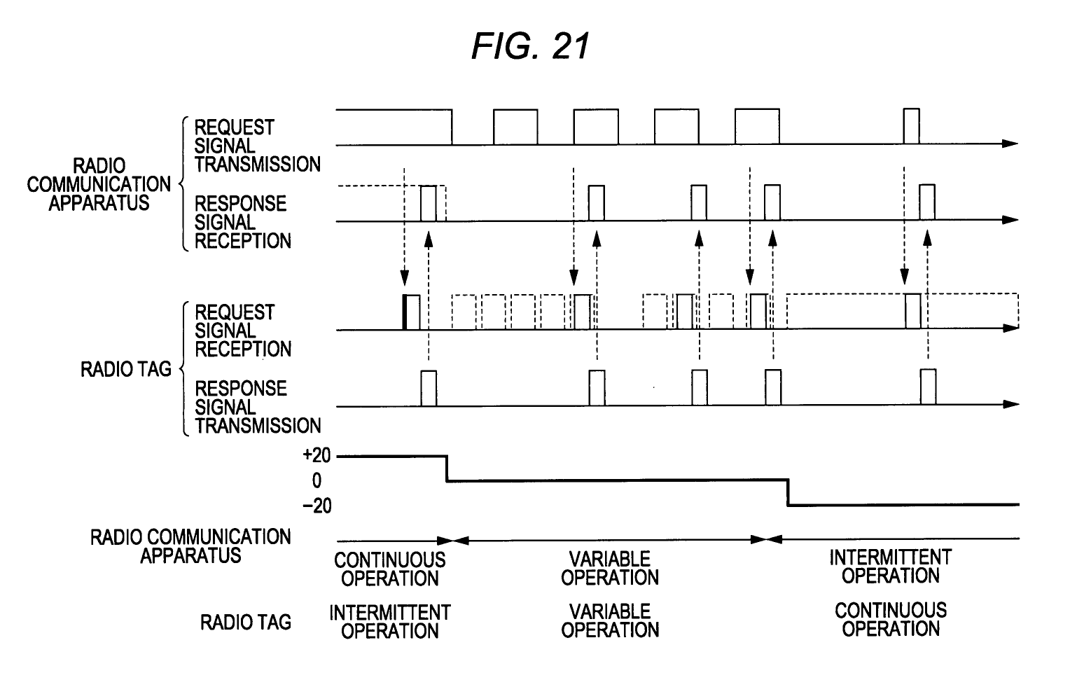

Next, the timing of processing between the components used in the radio communication system according to a fourth embodiment is described. FIG. 21 illustrates exemplary communication processing in the radio communication system according to a fourth embodiment. In the time chart illustrated in FIG. 21, the transmission of the request signal and the reception of the response signal in the radio communication apparatus 2, the reception of the request signal and the transmission of the response signal in the radio tag 1, the comparison result of the battery remaining amount, and the operation modes in the radio communication apparatus 2 and the radio tag 1 are illustrated from the top. Time is illustrated in the horizontal direction, and the communication processing is illustrated in time series. The description in FIG. 21 is based on the description in FIG. 7. The comparison result of the battery remaining amount in FIG. 21 illustrates the result of the comparison of the remaining amount of the electric power in the battery B2 to the remaining amount of the electric power in the battery B1. As a matter of convenience, the comparison result is illustrated at three example levels: +20%, 0, and −20%.

As illustrated in FIG. 21, the radio tag 1 and the radio communication apparatus 2 operate in the continuous operation mode, the intermittent operation mode, or the variable operation mode determined based on the comparison between the respective battery remaining amounts of the radio tag 1 and the radio communication apparatus 2.

As described above, in the radio communication system according to a fourth embodiment, the operation time can be adjusted more flexibly by setting the variable operation mode.

In a fifth embodiment, the battery remaining amount in a fourth embodiment may be converted into a remaining operable time. Namely, the fifth embodiment can be a combination of the third and fourth embodiments. In the fifth embodiment, the same components as those in any of the first to fourth embodiments are assigned with the same reference numbers, and the first to fourth embodiments are referred to for description thereof. Therefore, the description of the same components is not repeated.

The remaining amount detecting part 17 in the radio tag 1 according to the fifth embodiment detects the remaining amount of the electric power in the battery B1 and converts the detected remaining amount of the electric power in the battery B1 into the remaining operation time. The remaining amount comparing part 18 outputs a result obtained by subtracting the reference value (such as the remaining operation time in the battery B2) from the remaining operation time in the battery B1, as the comparison result information to the intermittent control part 19. The intermittent control part 19 determines the operation mode based on the comparison result information with the use of the graph of FIG. 6 and the table of FIG. 7 in a fourth embodiment, which are respectively converted into a graph and a table corresponding to the comparison result information based on the remaining operation time.

Also in the radio communication apparatus 2 according to the fifth embodiment, the remaining amount detecting part 26 detects the remaining amount of the electric power in the battery B2 and converts the detected remaining amount of the electric power in the battery B2 into the remaining operation time. The remaining amount comparing part 27 outputs a result obtained by subtracting the reference value, that is, the remaining operation time in the battery B1 from the remaining operation time in the battery B2, as the comparison result information to the intermittent control part 28. The intermittent control part 28 determines the operation mode based on the comparison result information with the use of the graph of FIG. 6 and the table of FIG. 7 in a fourth embodiment, which are respectively converted into the graph and the table corresponding to the comparison result information based on the remaining operation time.

Since the other configuration and processing are similar to those in a fourth embodiment, a fourth embodiment is referred to for description thereof, and the description is not repeated.

The embodiments include a technical embodiment, in which the intermittent control may be performed in the radio communication apparatus, and the operation mode is changed based on the comparison between the battery remaining amounts of respective apparatuses. The components, the circuit configuration, and the processings can be suitably designed according to the technical embodiment.

In addition, according to an embodiment, a radio communication system disclosed in the application includes a radio communication apparatus, which has a communication part for transmitting a request signal requesting a response to a radio tag, and the radio tag which transmits a response signal in response to a reception of the request signal from the radio communication apparatus. The radio communication apparatus includes a remaining amount detecting part, a comparing part, and an intermittent control part. The remaining amount detecting part detects a remaining amount of a radio communication apparatus battery which is the electric power source of the radio communication apparatus. The comparing part compares remaining amount information, indicating the detected remaining amount, with a reference value. The intermittent control part makes the communication part continuously transmit the request signal when it is determined that the value indicated by the remaining information is not less than the reference value based on the comparison by the comparing part, and makes the communication part transmit the request signal at an interval of a set stop time during a set operation time when it is determined that the value indicated by the remaining information is less than the reference value. According to an embodiment, in the radio communication apparatus, the electric power consumption of the battery, which is the electric power source of the radio communication apparatus, can be suppressed by performing the continuous operation or the intermittent operation in the communication part according to the remaining amount of the radio communication apparatus battery which is the electric power source of the radio communication apparatus, whereby the operation time can be extended.

Further, the radio tag of the radio communication system in an embodiment includes a tag battery remaining amount detecting part for detecting the remaining amount of a radio tag battery, which is the electric power source of the radio tag, and for transmitting tag battery remaining amount information, indicating the detected remaining amount, to the radio communication apparatus. The comparing part provided in the radio communication apparatus performs comparison using a value according to the tag battery remaining amount information received from the radio tag as the reference value. According an embodiment, by setting the reference value with which the remaining amount of the radio communication apparatus battery which is the electric power source of the radio communication apparatus is compared according to the remaining amount of the radio tag battery which is the electric power source of the radio tag, the remaining amount of the radio communication apparatus battery which is the electric power source of the radio communication apparatus can be compared to the remaining amount of the radio tag battery which is the electric power source of the radio tag, to control the operation of the radio communication apparatus.

Further, in the comparing part provided in the radio communication apparatus in the radio communication system disclosed in the application, the difference or the ratio between the value indicated by the remaining amount information and the reference value may be obtained, and the intermittent control part sets the stop time and the operation time based on the difference or the ratio obtained by the comparing part. According to an embodiment, the remaining amount of the radio tag battery which is the electric power source of the radio tag and the remaining amount of the radio communication apparatus battery which is the electric power source of the radio communication apparatus are compared with each other, and the stop time and the operation time corresponding to the remaining amount comparison are set, whereby each operation in the stop time and the operation time corresponding to the remaining amount of the battery which is the electric power source of the radio communication apparatus is set. According to an embodiment, the operation time can be extended. The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A radio communication system comprising:
a radio communication apparatus having a communication part for transmitting a request signal requesting a response to a radio tag; and
a radio tag which transmits a response signal in response to the reception of the request signal from the radio communication apparatus,
wherein the radio communication apparatus comprises an intermittent control part which makes the communication part transmit the request signal at an interval of a given stop time during a given operation time.

2. The radio communication system according to claim 1, wherein the radio tag comprises a detecting part for detecting the presence of the request signal at a given starting interval, and the operation time in the radio communication apparatus is set to be longer than the starting interval in the radio tag.

3. The radio communication system according to claim 1, wherein the radio communication apparatus uses a battery as an electric power source.

4. A radio communication system comprising:
a radio communication apparatus having a communication part for transmitting a request signal requesting a response to a radio tag; and
a radio tag which transmits a response signal in response to the reception of the request signal from the radio communication apparatus,
wherein the radio communication apparatus comprises:
a remaining amount detecting part for detecting a remaining amount of a radio communication apparatus battery which is an electric power source of the radio communication apparatus;
a comparing part for comparing remaining amount information, indicating the detected remaining amount, with a reference value; and
an intermittent control part which makes the communication part continuously transmit the request signal when it is determined that the value indicated by the remaining amount information is not less than the reference value based on the comparison by the comparing part, and makes the communication part transmit the request signal at an interval of a given stop time during a given operation time when it is determined that the value indicated by the remaining amount information is less than the reference value.

5. The radio communication system according to claim 4, wherein the radio tag comprises:
a tag battery remaining amount detecting part for detecting a remaining amount of a radio tag battery which is an electric power source of the radio tag, the radio tag transmitting tag battery remaining amount information, indicating the detected remaining amount, to the radio communication apparatus, and
the comparing part in the radio communication apparatus performs comparison using a value according to the tag battery remaining amount information received from the radio tag as the reference value.

6. The radio communication system according to claim 5, wherein the communication part in the radio communication apparatus transmits remaining amount information, indicating the remaining amount detected by the remaining amount detecting part, to the radio tag, and
the radio tag comprises:
a comparing part for comparing the tag battery remaining amount, detected by the tag battery remaining amount detecting part, with the remaining amount indicated by the remaining amount information received from the radio communication apparatus; and
a detecting part which continuously detects the presence of the request signal when it is determined that the tag battery remaining amount detected by the tag battery is not less than the remaining amount indicated by the received remaining amount information based on the comparison by the comparing part, and detects the presence of the request signal at an interval of a given stop time during a given operation time when it is determined that the tag battery remaining amount detected by the tag battery is less than the value according to the received remaining amount information.

7. The radio communication system according to claim 4, wherein the comparing part in the radio communication apparatus obtains a difference or a ratio between the value indicated by the remaining amount information and the reference value, and the intermittent control part sets the stop time and the operation time based on the difference or the ratio obtained by the comparing part.

8. The radio communication system according to claim 4, wherein the remaining amount information indicating the remaining amount detected by the remaining amount detecting part is a remaining operable time calculated based on a percentage of the remaining amount to a given amount or based on the remaining amount.

9. A radio communication system comprising:
a radio communication apparatus having a communication part for transmitting a request signal requesting a response to a radio tag; and
a radio tag which transmits a response signal in response to the reception of the request signal from the radio communication apparatus,
wherein the radio tag comprises:
a tag battery remaining amount detecting part for detecting a remaining amount of a radio tag battery which is an electric power source of the radio tag;
a comparing part for comparing tag battery remaining amount information, indicating the detected remaining amount, with a reference value; and
a detecting part which continuously detects the presence of the request signal when it is determined that the value indicated by the tag battery remaining amount information is not less than the reference value based on the comparison by the comparing part, and detects the presence of the request signal at an interval of a given stop time during a given operation time when it is determined that the value indicated by the tag battery remaining amount information is less than the reference value.

10. A radio communication apparatus comprising:
a communication part for performing radio communication with another apparatus;
a remaining amount detecting part for detecting a remaining amount of a battery which is an electric power source;
a comparing part for comparing remaining amount information, indicating a value based on the detected remaining amount, with a reference value; and
an intermittent control part which makes the communication part perform continuous communication when it is determined that the value indicated by the remaining amount information is not less than the reference value based on the comparison by the comparing part, and makes the communication part perform communication at an interval of a given stop time during a given operation time when it is determined that the value indicated by the remaining amount information is less than the reference value.

11. A machine-readable medium comprising machine-executable instructions that cause a radio-communication apparatus to execute:
detecting a remaining amount of a radio communication apparatus battery which is an electric power source of the radio communication apparatus;
comparing remaining amount information, indicating the detected remaining amount, with a reference value;
transmitting continuously the request signal when it is determined that the value indicated by the remaining amount information is not less than the reference value based on the comparison; and
transmitting the request signal at an interval of a given stop time during a given operation time when it is determined that the value indicated by the remaining amount information is less than the reference value.
